(19) United States
(12) Patent Application Publication
(10) Pub. No.: US 2019/0144317 A1
(43) Pub. Date: May 16, 2019

(54) COLLECTOR WITH RETURN AND SILT BASIN, BUBBLER AND PROCESS

(71) Applicant: Randall L. Tucker, Findlay, OH (US)

(72) Inventor: Randall L. Tucker, Findlay, OH (US)

(21) Appl. No.: 16/308,722

(22) PCT Filed: Jun. 12, 2017
(86) PCT No.: PCT/US2017/037053

§ 371 Date: Dec. 10, 2018

Related U.S. Application Data
(60) Provisional application No. 62/349,065, filed on Jun. 12, 2016.

(51) Int. Cl. C02F 7/00; C02F 1/68; B01F 3/04; B08B 9/093

(52) U.S. Cl. CPC C02F 7/00; C02F 1/688; B01F 3/04248; C02F 2103/007; B01F 2003/04312; B01F 2003/04319; B01F 2215/0052; B08B 9/0933

(57) ABSTRACT

A collector includes one or more air/oxygen/gas introduction ports to form a bubbler that produces curtains of air/oxygen/gases into the waterway. The bubbler can be integrated into the collector, or formed as a separate component used with or without the collector. First and second pumps provide for improved removal of sediment collected in the collector cavity.

### BACKGROUND

This application claims the priority benefit of U.S. provisional application Ser. No. 62/349,065, filed Jun. 12, 2016, the disclosure of which is incorporated herein by reference.

The present disclosure relates to an apparatus, system, device, and method of removing sediment, sand, gravel, fines, organic material, silt, suspended material, debris, and/or particulates (generically referred to as sediment) from a waterway, etc. It is also capable of removing colloids, heavy metals and contaminants that travel near the bottom of the flow. The new collector is designed to cause the particles to fall out of the water column.

U.S. Pat. No. 6,042,733 (and patents claiming priority therefrom) relates to a collector that provides a simple, economical structure effective in filtering and removing sediment from a waterway, such as a river, stream, creek, irrigation channel, tidal pool, estuary pool, ocean, etc. The details of the U.S. Pat. No. 6,042,733 patent are expressly incorporated herein by reference. The collector is typically installed on a bottom surface or dug into the bottom surface of the waterway. A leading or upstream end of the collector includes a sloping or tapering surface that “compresses” the water and sediment as the water carrying the sediment moves up the ramp. At least one opening is provided near an apex and/or trailing edge of the collector and the opening is typically covered by a grate, screen, or prescreen that determines the size of the sediment that can enter the collector opening. The opening interconnects and communicates with an interior cavity of the collector. As the velocity of the water carrying the sediment travels over the apex and trailing edge, the velocity of the water slows and heavier sediment settles from the flow and passes through the opening into the collector cavity.

A sediment removal passage or suction passage communicates with the cavity and periodically (or continuously) the collected sediment slurry is removed from the collector. This sediment slurry is preferably conveyed or removed to a filter that is typically mounted on the bank or shore of the waterway. A suction force, for example provided by a pump (either onshore and/or housed in the cavity of the collector), directs the sediment slurry through the removal passage and directs the slurry to the filter where the water is separated from the sediment. Cleaner or filtered water is then returned to the waterway. The pump is typically operated on a periodic basis to remove the sediment gathered in the collector cavity, although it will be appreciated that in some systems it may be desirable to operate the pump continuously in order to remove sediment on a constant basis. Even then, the amount of sediment and the need to periodically remove the sediment from the collector requires improvement in the collector and process of removing the sediment.

The above-described technology has been successful at effectively and efficiently removing sediment from a waterway, although a need exists to also address removal of a particular type of sediment, i.e., silt, from the waterway. In particular, capturing silt in addition to other sediment would be a substantial improvement and heretofore has not been effectively achieved. It would also be desirable to capture the silt with the same device that is used for sediment removal. In part because the same collector is used to achieve this removal, and also for purposes of brevity, it will be understood that the term “sediment’ should also be construed herein to include silt (e.g., fine, organic material) that is collected and removed from the waterway.

A need also exists to coordinate operation of the system for a large scale collector, e.g., on the order of over 30 feet or greater. Individual, smaller sized collectors can be effectively manufactured, shipped, and subsequently assembled or joined together to address a need for a large scale collector.

Therefore, a need exists to address these problems and others in an effective, economical manner.

### SUMMARY OF THE INVENTION

The present invention provides a collector that meets the above-noted needs and others in a simple, effective, and economical manner.

In one aspect, the collector includes one or more air/oxygen/gases introduction ports to form a bubbler that produces curtains of air/oxygen/gases into the waterway.

The air/oxygen/gas is introduced into the waterway from the collector, preferably at or near the apex where sediment is collected in the cavity or hopper of the collector.

In another aspect, the collector includes a mechanism or means for controlling suction/intake during the pumping sequence to effectively remove sediment from the cavity.

The preferred collector includes first (inject) and second (suction) pumps that are controlled by variable frequency drives (VFD) and a programmable logic controller (PLC) to control the speed of the pumps, and likewise control the water flow (typically measured in gallons per minute (GPM)).

For example, one preferred process handles removal of sediment that has migrated into the cavity or hopper of the collector. Both pumps are initially off. At start-up, the first/inject pump is started and operated at an elevated speed (e.g., maximum GPM). The inject pump directs water flow through a first/inject port that communicates with the sediment in the hopper, and the sediment is loosened. Thereafter, the second/suction pump is started and operated at the same speed as the first pump thereby allowing the system to flush a second/suction port with water from the inject pump. Subsequently, the sediment and water exit the hopper through the suction port. The speed of the first pump is reduced which allows the difference of the flow rates of the pumps to be balanced out by suctioning the hopper flow into the suction port and to the discharge. By subsequently increasing the speed of the first pump, sediment suction then decreases from the hopper, and the suction port/line is purged with sediment-free suction water purging the system. Next the suction pump is shut down after being purged and the inject pump speed increased to pump directly into the hopper and make sure the collector is not bridged. Thereafter the inject pump is shut down.

In another aspect of the present disclosure, one or more gas bubblers are operatively associated with the collector.

The gas bubbler introduces oxygen or air or potentially other gases (generically referred to herein as gas) into the waterway, preferably in regions adjacent the collector opening so that the small diameter gas bubbles or curtains of gas bubbles interact with silt carried in the water and cause the silt to precipitate into the collector opening where it is subsequently removed from the waterway with the rest of the sediment collected in the collector cavity.

In one preferred arrangement, a series of adjacent small-diameter apertures are provided along the width of the collector adjacent the collector opening to produce curtains of bubbles rising upwardly from the collector into the waterway, and particularly into the waterway above the collector.

In another aspect, a preferred arrangement includes first and second gas bubblers disposed in spaced relation (i.e., upstream and downstream from one another).

In still another aspect, the gas bubblers are also disposed at different heights along the collector.

Still other benefits and advantages of the invention will become apparent to those skilled in the art upon reading and understanding the following detailed description.

### BRIEF DESCRIPTION OF THE DRAWINGS

FIG. 1 is a perspective view of a collector.

FIG. 2 is a plan view of the collector.

FIG. 3 is an end view of the collector.

FIG. 4 is a sectional representation of the hopper portions.

FIG. 5 is a schematic representation of a collector system.

FIGS. 6-10 are schematic representations of an operating sequence for a collector, for example, as shown in FIG. 1.

FIG. 11 is a perspective view with selected portions shown cut away or removed for ease of illustration of a gas bubbler assembly associated with the collector.

FIG. 12 is another alternative, overhead perspective of the collector with the gas bubbler assembly of FIG. 8.

FIG. 13 illustrates internal details of a dual hopper arrangement with interconnected compartments.

FIG. 14 is a perspective view from the underside of the collector of FIG. 8.

FIG. 15 is a perspective view of a gas bubbler assembly that may be physically separated from the collector.

FIG. 16 is a cross-sectional view of the gas bubbler assembly of FIG. 15.

FIG. 17 is an enlarged, detailed view of the encircled portion of FIG. 16.

### DETAILED DESCRIPTION OF THE INVENTION

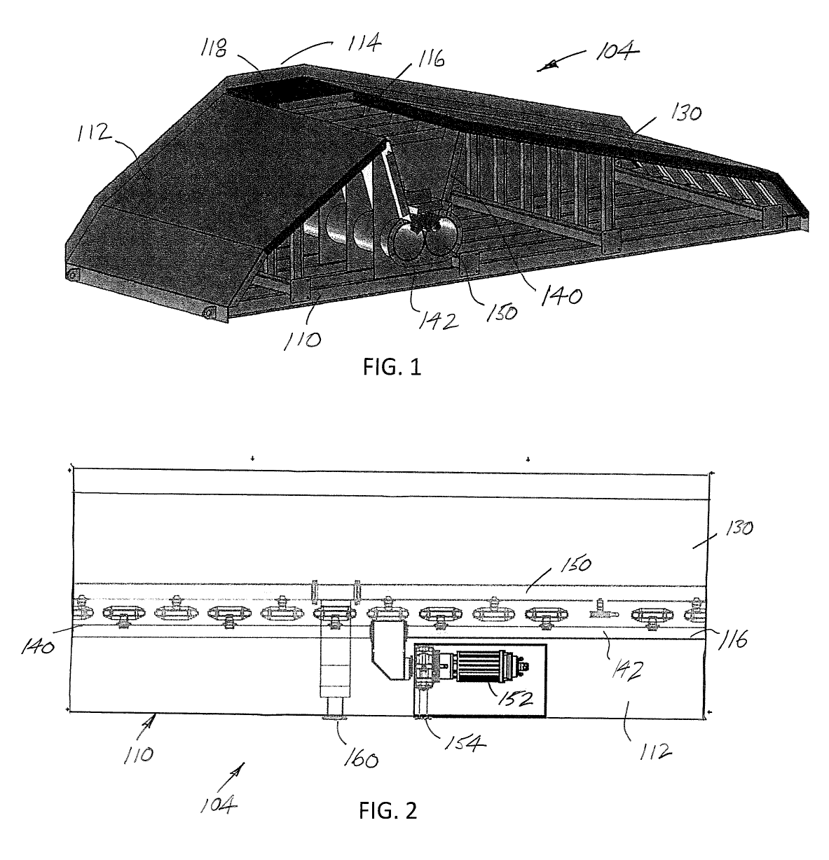

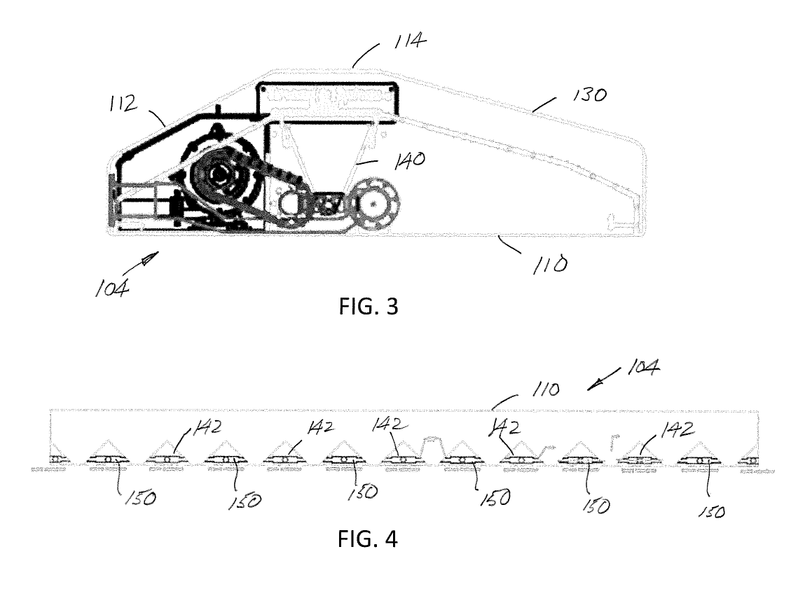

FIGS. 1-5 illustrate a collector system 100 used in a waterway 102 for selectively removing sediment (sand, gravel, fines, organic material, silt, suspended material, debris, particulates, colloids, heavy metals, and/or contaminants) therefrom. The collector system 100 (that preferably includes one of more collectors 104) is typically located and secured along a base or bottom surface 106 of the waterway 102 or partially embedded in the bottom surface of the waterway and usually oriented in a direction angled or generally perpendicular to the water flow (WF) to extend across the waterway. If multiple collectors 104 are used, the collectors are interconnected via connectors, for example, at each end of the system 100. Thus, it will be appreciated that a series of collectors 104 can be connected together, e.g., daisy-chained, to extend across various widths of the waterway 102 or a portion of the width of the waterway.

With continued reference to FIG. 1, one type of collector 104 includes a housing 110 having a leading, sloping upper first surface (upstream ramp) 112 that extends to an apex 114. The apex includes an opening or openings 116, and may also be covered by a coarse screen or grate 118 that further regulates the size of material (including sentiment) that is removed by the collector 104 from the waterway 102. A trailing second surface or downstream ramp 130 extends downwardly from the apex 114 usually at a greater angle than the first surface 112. Although not shown, it is also contemplated that the trailing surface 130 may include supplemental openings to capture additional sediment that does not enter the opening(s) 116. The opening(s) 116 and any supplemental openings communicate with an internal cavity or hopper 140, although in some instances the cavity is divided into multiple compartments, e.g., the cavity may be divided into separate first (upstream) and second (downstream) compartments 140a, 140b. A sediment removal or suction passage(s) 142 communicates with the compartments of the cavity and is typically connected to a suction (not shown) line or passage that extends from the collector(s) 104 along the side of the waterway 102. Likewise, an additional removal/suction passage 144 may be provided for silt removal (FIGS. 8-12).

A pressurized line 150 extending from a pump 152 (e.g., 200 gallons per minute at 100 psi) communicates with the cavity compartments 140 of the collector 104 and flushes the cavity compartments, for example, provides a venturi action in an ejector so that a suction force is provided to the suction/dredge line to draw the collected sediment from the cavity. The pump 152 may be housed within the collector 104 and/or may be located outside the waterway and interconnected thereto by a line. Sediment slurry flow proceeds from the collector 104 through line 154 to a separator or filter assembly 156 located outside the waterway 102. In this manner, sediment 158 is removed or separated from the water by directing the sediment slurry from the collector cavity 140 through the filter 156, and a clean water return line 160 proceeds toward the waterway 102. The pump 152 preferably has its own intake line 162 submerged in the waterway 102 and thereby provides the pressure flow to line 154 as required for efficient operation.

Use of adjacent, dual hoppers (FIGS. 6-10) make a sediment collector system more efficient and provides protection from plugging of the hoppers when excess sediment accumulates on top of the collector is also envisioned. Typically, in a closed loop system, water is re-introduced or re-injected in the top of the hopper. This provides reuse of the water for extracting the sediment but does not help resolve the issue associated with plugging of the hoppers, because the injection location is typically located on the leading and trailing edges of the channel close to the top of the hopper. Another approach as shown in FIGS. 6-10 is to provide injection into the bottom of the hopper directly across and coaxially to the suction. This approach provides return water in close proximity to the opposite suction port. This further provides the ability to remove the entrained sediment from the hopper as the sediment is mixed into the injected water being suctioned out by the suction port. This feature also provides for the system to be able to pump down without being sediment locked. Specifically, it is proposed to have alternating suction manifolds and injection manifolds, these replaceable urethane manifolds having replaceable ports with varying orifice sizes that allow for the tuning of the suction water injection to balance the collector extraction capability across the entire width of the collector. Use of a suction metering plate also gives the ability to meter the sediment if so required.

In addition, a transversely, internally mounted, submersible dredge pump solves the problem of suction head distance limitations. That is, shore mounted pumps are more limited because of the distance between the collector and the pump due to suction head. This distance limitation reduces the number of applications in which the standard collector can be used. An internally mounted submersible dredge pump, though, provides for unlimited distances in installation applications.

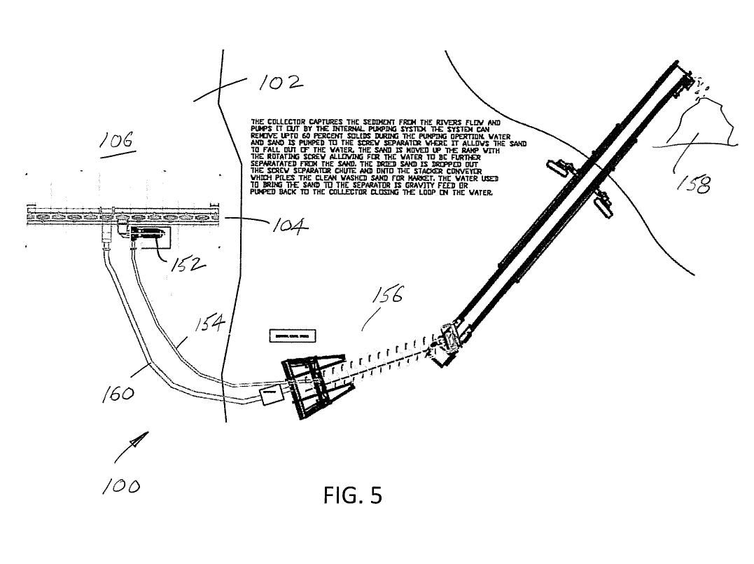

In the schematically illustrated system of FIG. 5, the collector 104 captures sediment from the waterway flow and pumps the sediment out via the internal pumping system. The system can remove up to approximately 60% solids during the pumping operation, water and sediment being pumped to a screw separator. The screw separator allows the sediment to fall out of the water, the sediment is moved up an elongated ramp with the rotating screw allowing for the water to be further separated from the sediment. The “dried” or dewatered sediment is dropped from the screw separator chute onto the stack or conveyor which piles the clean washed sediment for market (e.g. sand, etc.). The water used to bring the sediment to the separator is gravity fed or pumped back to the collector or waterway, thereby closing the loop with the waterway, i.e., the water is reintroduced into the waterway.

In FIGS. 6-10, the description of the operating sequence for advantageously removing sediment from the collector in accordance with this aspect of the present disclosure is shown. The drawings make the assumption that the sediment has migrated or is already migrating to the hopper(s). Pressurized or injected water and suction pumps are operational. The inject pump and suction pumps are controlled by variable frequency drives (VFDs) and a programmable logic controller (PLC) to control on/off, and/or the speed of the pumps, controlling the flow or gallons per minute (GPM). Not shown is a diverter which is positioned above each port to prevent direct movement of sediment into the suction port allowing the suction port to be purged.

The preferred sequence is as follows. FIG. 6 shows the system at the pumping start up. The suction pump is off, the inject pump is started and run at maximum GPM. The flow of each port stays in the hopper and loosens the sediment eliminating bridging of the hopper.

Next, FIG. 7 shows the system with both suction and inject pumps operating at the same GPM. This allows the system to flush the suction with sediment free water from the inject pump.

In the next step of the preferred sequence, FIG. 8 shows the suction pump running at a set GPM. The inject pump is slowed down which allows the difference of the pumps GPM is balanced out by suctioning in the hopper into the flow of the suction and on to the discharge.

Next, FIG. 9 shows the suction pump running at a set GPM. The inject pump speed is increased to match the suction GPM. The sediment suction is decreased and the suction line is purged with sediment free suction water purging the system.

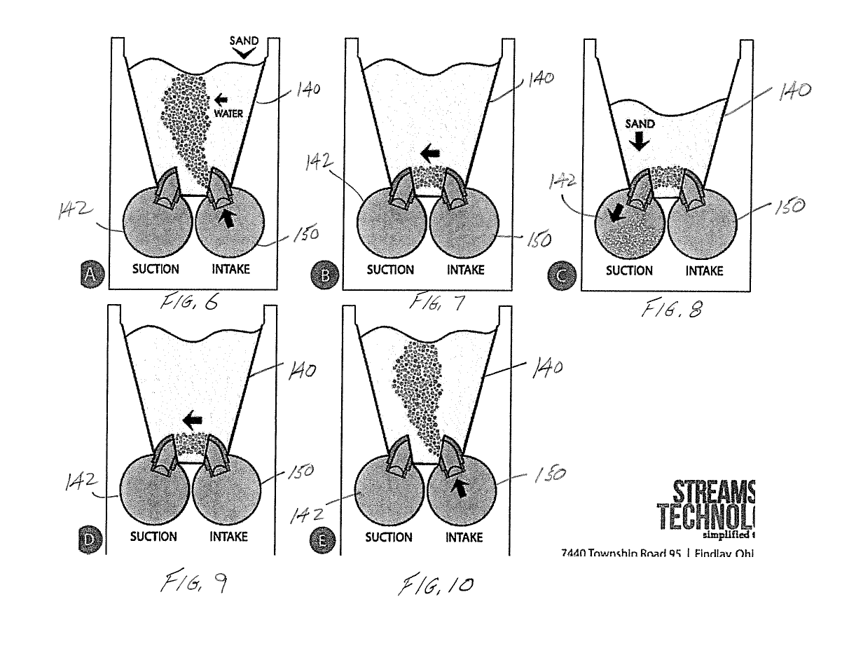

FIG. 10 shows the suction pump at shut down after the purging step of FIG. 9. The inject pump is increased to maximum GPM which pumps directly into the hopper making sure the collector is not bridged. The inject pump is subsequently shut down ending the sequence.

The collector may be advantageously used to beneficially pre-wash sand. For example, as water proceeds outwardly from the collector opening (FIGS. 6 and 10), any sand that enters the collector through the grate in a direction opposite to the positive flow will be stripped of organic matter and fines. Large particles of a predetermined threshold density, however, will pass through. The reverse turbulence can strip the fines from the surface of the sand. If the flow is large enough, it can even keep Sand out of the collector and only allow heavier particles such as gravel to be captured in the collector. One skilled in the art will appreciate that this feature consequently allows fine tuning of the size/type of sediment that is collected.

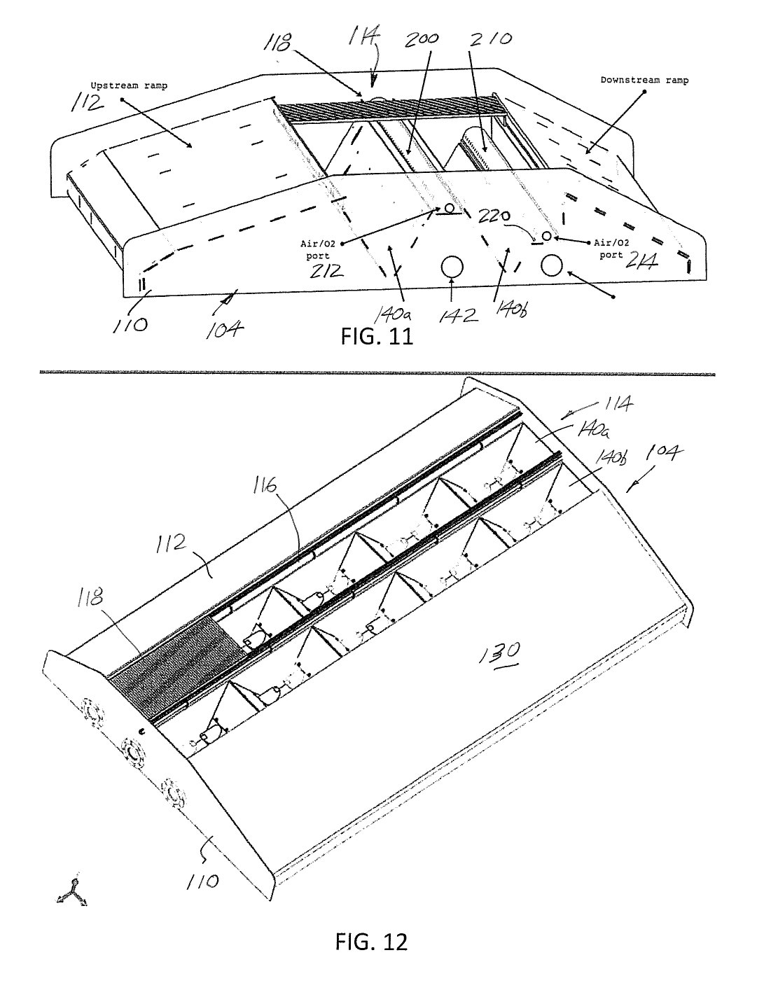

For ease of understanding, like reference numerals will refer to like components in the embodiment shown in FIGS. 11-14, and new reference numerals will be used to refer to new components. More particularly, the collector 104 is again part of an overall collector system, for example as shown in FIG. 5, whereby the collector is inserted into the waterway or at least partially received in the bottom surface of the waterway. Housing 110 includes a first or upstream ramp or surface 112 that leads to an apex 114 that has one or more openings 116 to receive the sediment. A screen or grate is preferably disposed over the opening 116 to control the size of particles removed by the collector 104. A second or downstream ramp or surface 130 is disposed on the downstream side of the housing.

In this embodiment, dual hoppers 140a, 140b are used to collect sediment (including silt as will be more particularly described below). The hoppers 140a, 140b are disposed adjacent to one another and are shown here in back-to-back or upstream/downstream relation. The cavities or hoppers 140a, 140b are designed to receive sediment in the same manner as described above, and likewise the sediment slurry is selectively pumped from the collector either in a manner well known in the art such as in the '733 patent, or in the manner described above.

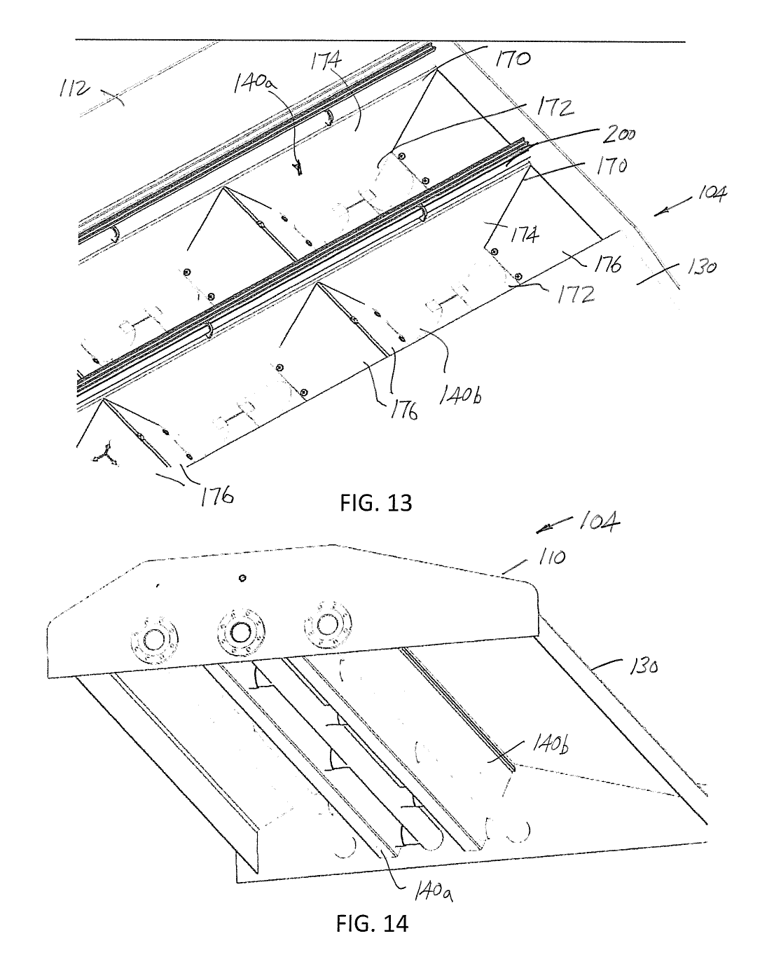

Each hopper 140, 140b may include, by way of example only, distinct sections extending the width of the collector 104. The hoppers 140a, 140b collectively define the internal cavity 140 that receives sediment through opening 116 that is covered by the screen/grate 118. Each unit or hopper 140a, 140b may be a removable insert that is removably inserted into the cavity of the collector if desired. For example, the hopper 140 would be manufactured of a durable, wear-resistant material such as urethane. Each hopper has a generally funnel or hopper shape that temporarily stores and transfers sediment from an upper end 170 to a narrow, second end 172. Tapered sidewalls 174 of the hopper 140 provide a funneling action in the upper portion of each hopper. In addition, tapering dividers 176 (FIGS. 12-13) may be provided in the width direction of the collector to direct the sediment toward the base portion. Of course, it will be appreciated by one skilled in the art that the hoppers need not be formed as removable inserts and, instead, tapered sidewalls can be formed in the collector to perform the same function.

As will be appreciated, when the sediment slurry is pumped from the collector cavity, the suction force draws additional water and sediment from the waterway because the collector cavity communicates with the waterway through the opening. In certain applications, it is desirable to reduce or limit the amount of water intake that enters the collector during the pumping sequence. In other instances, it is desirable to regulate the type of material that is captured by the collector, i.e., to further control the type of sediment that is removed from the waterway. As is known from the '733 patent, the slope of the collector surfaces and the size of the openings and mesh size of the grates/screens generally determine what size and type of materials are collected. In some instances, however, a flat collector (i.e., a collector without the sloped surfaces) may still be desirable and advantageously allows selectivity of the type of material removed from the waterway. The addition of a second upstream designed ramp in place of the downstream ramp will allow for use of a collector in a bi-directional mode such as a tidal or coastal application.

First and second gas bubblers 200, 210 (FIG. 11) are provided in the collector 104. The spaced apart gas bubblers receive air, oxygen, or another gas, for example, through respective ports 212, 214. The gas bubblers 200, 210 are shown in this arrangement as extending over the entire width of the collector. Each of the gas bubblers 200, 210 have a series of small openings that communicate with the gas supply via the ports 212, 214 to produce a curtain of bubbles rising upwardly from the collector into the waterway. As is also apparent, the upstream gas bubbler 200 is located at a different height than the downstream gas bubbler 210, and in this particular embodiment the upstream gas bubbler 200 is disposed at an apex between adjacent, tapering walls of the upstream and downstream hoppers 140a, 140b, while the downstream gas bubbler 210 is disposed on a ledge 220 that is disposed at approximately mid-height of the downstream tapering wall of the downstream hopper 140b.

The gas bubblers introduce oxygen or air or potentially other gases (generically referred to herein as gas) into the waterway, preferably in regions adjacent the collector opening so that the small diameter gas bubbles or curtains of gas bubbles interact with silt carried in the waterway and cause the silt to precipitate into the collector opening where the silt is subsequently removed from the waterway with the rest of the sediment collected in the collector cavity. A series of adjacent small-diameter apertures are provided along the width of the collector adjacent the collector opening to produce the curtains of bubbles that rise upwardly from the collector through which the gas passes from the bubblers into the waterway, and particularly into the waterway above the collector. Thus, in addition to removing particulate matter such as sand, small gravel, etc., when equipped with the gas bubblers, the collector system also addresses the need to remove silt from the waterway.

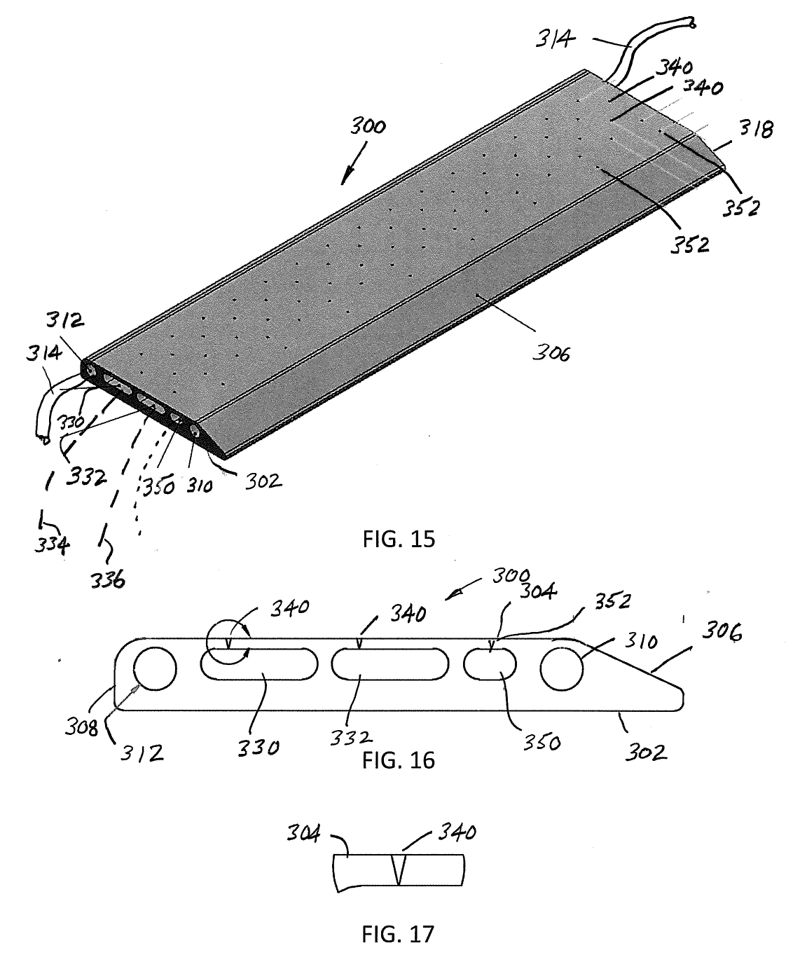

FIGS. 15-17 illustrate a gas bubbler assembly 300 that is intended to be physically separated from the collector assembly in treating a waterway. More particularly, the gas bubbler assembly is an extruded urethane body, housing, or structure 300 that allows flexibility, for example, in manufacture, assembly, shipping, and deployment. The gas bubbler assembly 300 has a lower, first surface 302 that is shown as a planar surface and allows the bubbler assembly to be received on the bottom of the waterway. An upper, second surface 304 of the body allows the water in the waterway to flow over the bubbler assembly 300. To that end, an upstream edge 306 of the body 300 is a gradual incline or ramp surface while a second edge 308 defines a sharper cut off or squared edge.

The gas bubbler assembly 300 includes a mounting structure which in a preferred arrangement is formed by first and second elongated openings 310, 312 that extend through the entire length of the body. Preferably opening 310 is adjacent the upstream edge 306 of the bubbler assembly 300 while opening 312 is located adjacent the downstream edge 308. The openings 310, 312 are dimensioned to each receive a securing member, e.g. a stainless steel cable 314, only one of which is shown in FIG. 15. As will be appreciated, the cable 314 extends outwardly from opposite ends 316, 318 of the elongated body. The cable 314 may extend into similar openings provided in adjacent bubblers (not shown) to allow one bubbler body 300 to be joined to an adjacent body so that the bubblers can be secured together in end-to-end fashion across the waterway or portions of the waterway. Proximal and terminal ends of the body(ies) 300, are then secured to the waterway by fastening the cable 314 to a desired securing structure, e.g. tree, pier, stake, etc. to hold the bubbler assembly in place in the waterway.

In addition, the gas bubbler assembly 300 preferably includes first and second gas or airway passages 330, 332 that also extend through the entire length of the bubbler body and are in fluid communication with a pressurized supply (not shown) of gas (e.g. air, oxygen, etc.) supplied via respective gas lines represented at 334, 336 (FIG. 15). Because the bubbler bodies 300 may be secured to one another in end-to-end relation, it will be appreciated that suitable interconnecting structure may be provided so that gas passages 330, 332 in adjacent bodies are in fluid communication with one another. The gas passes lengthwise through the body 300 and is introduced into the waterway via smaller diameter openings 340, preferably V-shaped openings, that communicate with a respective one of the gas passages 330, 332 and open outwardly through the surface 304 of the bubbler body. The openings 340 are preferably periodically spaced along the length of the body surface 304. Once secured in the waterway, and the gas introduced into passages 330, 332 via supply lines 334, 336, curtains of bubbles rise from the surface 304 of the bubbler body 300 upwardly through a water column defined in the waterway above the openings 340. In the same manner as the bubbler described with the earlier embodiments herein, the bubble curtain(s) interact with particles in the waterway, such as silt, whereby the particles drop out of the flow of the waterway and the particles/silt/contaminants attached to the particulates and settlement, are effectively removed by the collector.

Another enhancement is to include a chemical injection chamber or passage 350 that also extends through the length of the bubbler body 300. The passage 350 is adapted to receive one or more of a known soluble chemical(s) intended to decontaminate or to improve water quality, such as ferrite, alum, etc., and is preferably supplied to the passage in a soluble form. Preferably, the passage 350 and associated openings 352 are disposed upstream of the bubble curtains so that when released into the waterway, the churning action of the bubbles cause a desired mixing of the chemical in the waterway. This helps to distribute the soluble chemical emitted through openings 352 throughout the waterway as the water is naturally advanced from an upstream position and passes downstream through first and or second bubble curtains emitted from openings 340.

As will be appreciated from a review of the structure illustrated in FIGS. 15-17, the cross-sectional conformation of FIG. 16 indicates how the bubbler body may be an extruded structure for ease of manufacture. Each of the passages or openings 310, 312, 330, 332, and 350 preferably extends through the entire length of the bubbler body 300. The openings 340, 352 can be subsequently formed in the upper surface 304 to communicate with the desired passage 330, 332, or 350. Additionally, openings 310, 312 receive the cables to secure the body to the waterway. Once cured, the extruded body may be shipped in planar form or alternatively rolled up for ease of shipping, and as noted above, two or more of the bubbler bodies may be joined together to provide an extended length bubbler where needed. This written description uses examples to describe the disclosure, including the best mode, and also to enable any person skilled in the art to make and use the disclosure. The patentable scope of the disclosure is defined by the claims, and may include other examples that occur to those skilled in the art. Such other examples are located adjacent the downstream and. Intended to be within the scope of the claims if they have structural elements or process steps that do not differ from the same concept, or if they include equivalent structural elements or process steps with insubstantial differences.

Moreover, this disclosure is intended to seek protection for a combination of components and/or steps and a combination of claims as originally presented for examination, as well as seek potential protection for other combinations of components and/or steps and combinations of claims during prosecution. For example, select features of the first embodiment of FIGS. 1-10 may be used with select features of the second embodiment of FIGS. 11-14, and vice versa. In addition, the embodiment of FIGS. 15-17 likewise may be used with the first embodiment of FIGS. 1-10 or still other collector assemblies. Moreover, the concepts described herein are fully scalable for all applications. Preferably, the invention uses HDPE components in wear points and piping, although alternative materials that achieve the same benefits may also be considered. A typical collector includes a 30′ downstream distance, each section 11′, 11.5″ wide so that is can fit on a conventional semi-trailer without escort, 84″ high from includes bottom of collector to top of grate, 304 Stainless Steel Grate has 1′ openings with 1″ bars with a downstream distance of 3′ 11″, and has a total weight of each segment of approximately 24,000 lbs. Four lifting points are preferably provided. Segments are secured together with fasteners such as galvanized bolts. Two″ passages, such as 20″ schedule 40 steel pipes, are installed in each segment after multiple segments are assembled and then a continuous passage, such as an 18″ DR11 HDPE pipe, is installed and ports or openings, e.g., 5 1/2 ″ port holes, are drilled and the ports installed. This allows all components that would eventually wear to be able to be replaced. The 18″ HDPE Pipe means that this system would need a pump in the range of 2500-4500 GPM to prevent sediment fall out of flow in the piping. The components are coated with suitable corrosion resistant material such as an epoxy painted with marine grade components. Again, these are preferred processes of manufacture and assembly.

The collector is typically manufactured of a durable material(s) such as metal, urethane, and/or concrete. The bubbler would preferably be formed of a urethane material, although various other materials of construction that are particularly suitable for the intended use and environment may be used to form the collector and/or bubbler without departing from the scope and intent of the invention.

1. A bubbler for introducing gas into an associated waterway, the bubbler comprising:
a housing having an upper surface with an elongated conformation extending from a first end to a second end;
a first passage extending through the housing from the first end to the second end;
a connecting cable dimensioned for receipt in the first passage and extending therethrough to secure the housing to the associated waterway;
a first airway extending through the housing from the first end to the second end; and
plural openings extending through the upper surface communicating with the first airway.

2. The bubbler of claim 1 further comprising a chemical chamber communicating with some of the plural openings for introducing a soluble chemical into the waterway.

3. The bubbler of claim 1 further comprising a second airway spaced from the first airway and extending through the housing from the first end to the second end, the second airway communicating with some of the plural openings.

4. The bubbler of claim 1 further comprising a second passage extending through the housing from the first end to the second end to secure the housing to the associated waterway.

5. The bubbler of claim 1 wherein the housing has an extrudable cross-sectional configuration that allows the housing to be easily extrusion molded.

6. A collector assembly with integrated bubbler comprising:
a collector housing having a lower, first surface configured for receipt on an associated bottom surface of an associated waterway, and an upper, second surface over which water flows, the collector housing further including an internal cavity in fluid communication with the associated waterway via an opening in the second surface, the housing having a first ramp at an upstream end, and a second ramp at a downstream end;
a first bubbler operatively associated with the collector housing and positioned adjacent the opening that emits pressurized gas into the associated waterway;
a second bubbler operatively associated with the collector housing and positioned adjacent the opening that emits pressurized gas into the associated waterway, the second bubbler disposed in spaced relation from the first bubbler.

7. The collector assembly of claim 6 wherein the first and second bubblers are spaced from one another between the upstream end and the downstream end of the collector housing.

8. The collector assembly of claim 7 wherein the first and second bubblers are spaced from one another in a direction oriented between the first and second surfaces of the collector housing.

9. The collector assembly of claim 6 wherein the first and second bubblers are spaced from one another in a direction oriented between the first and second surfaces of the collector housing.

10. The collector assembly of claim 6 wherein the cavity is divided into first and second cavity portions oriented relative to one another between the upstream and downstream ends of the collector housing.

11. The collector assembly of claim 10 wherein the first bubbler is interposed between the first and second cavity portions.

12. The collector assembly of claim 11 wherein the second bubbler is positioned adjacent a downstream end of the second cavity portion.

13. The collector assembly of claim 12 wherein the second bubbler is located in the second cavity portion spaced further from the first surface than the first bubbler is spaced from the first surface.

14. The collector assembly of claim 6 further comprising a discharge passage in communication with the cavity through which sediment collected in the cavity is removed from the collector housing.

15. A collector assembly for removing sediment from an associated waterway, the collector assembly comprising:
a collector housing having a lower, first surface configured for receipt on an associated bottom surface of an associated waterway, and an upper, second surface over which water flows, the collector housing further including an internal cavity in fluid communication with the associated waterway via an opening in the second surface, the housing having a first ramp at an upstream end, and a second ramp at a downstream end;
a first port in communication with the cavity that injects pressurized fluid from a first pump into the cavity;
a second port in communication with the cavity at a location spaced from the first port and that removes water and sediment from the cavity; and
a controller that handles removal of sediment from the cavity by:
directing water through the first port by operating the first pump to loosen sediment in the cavity,
operating the second pump to flush the second port with water from the first pump,
continuing to operate the first and second pumps to remove sediment and water from the cavity through the second port,
reducing the speed of the first pump while the second pump continues to remove sediment and/or water from the cavity,
subsequently increasing the speed of the first pump, and
stopping the second pump and then stopping the first pump.

16. The collector assembly of claim 15 wherein the controller increases the speed of the first pump after stopping the second pump and before stopping the first pump.

17. The collector assembly of claim 15 wherein the second pump operating step includes operating the second pump at the same speed as the first pump until the first pump reducing step occurs.

18. The collector assembly of claim 15 further comprising a bubbler operatively associated with the collector housing and positioned adjacent the opening that emits pressurized gas into the associated waterway.

19. The collector assembly of claim 18 further comprising a second bubbler operatively associated with the collector housing and positioned adjacent the opening that emits pressurized gas into the associated waterway, the second bubbler disposed in spaced relation from the first bubbler.

20. The collector assembly of claim 19 wherein the first and second bubblers are spaced from one another between the upstream end and the downstream end of the collector housing.

21. The collector assembly of claim 20 wherein the first and second bubblers are spaced from one another in a direction oriented between the first and second surfaces of the collector housing.

22. The collector assembly of claim 19 wherein the first and second bubblers are spaced from one another in a direction oriented between the first and second surfaces of the collector housing.

23. The collector assembly of claim 19 wherein the cavity is divided into first and second cavity portions oriented relative to one another between the upstream and downstream ends of the collector housing.

24. The collector assembly of claim 23 wherein the first bubbler is interposed between the first and second cavity portions.

25. The collector assembly of claim 24 wherein the second bubbler is positioned adjacent a downstream end of the second cavity portion.

26. The collector assembly of claim 25 wherein the second bubbler is located in the second cavity portion spaced further from the first surface than the first bubbler is spaced from the first surface.

27. A process of removing sediment from a cavity of a waterway sediment collector assembly that includes first and second ports communicating with the cavity, and first and second pumps, and a controller that controls operation of the first and second pumps, the process comprising:
directing water through the first port by operating the first pump to loosen sediment collected in the cavity;
operating the second pump to flush the second port with water from the first pump;
continuing to operate the first and second pumps to remove sediment and water from the cavity through the second port;
reducing the speed of the first pump while the second pump continues to remove sediment and/or water from the cavity;
subsequently increasing the speed of the first pump; and
stopping the second pump and then stopping the first pump.

28. The process of claim 27 further comprising increasing the speed of the first pump after stopping the second pump and before stopping the first pump.

29. The process of claim 27 wherein the second pump operating step includes operating the second pump at the same speed as the first pump until the first pump reducing step occurs.

30. The process of claim 27 wherein the collector assembly includes a bubbler for introducing gas into an associated waterway.

31. The process of claim 30, the bubbler comprising:
a housing having an upper surface with an elongated conformation extending from a first end to a second end;
a first passage extending through the housing from the first end to the second end;
a connecting cable dimensioned for receipt in the first passage and extending therethrough to secure the housing to the associated waterway;
a first airway extending through the housing from the first end to the second end; and
plural openings extending through the upper surface communicating with the first airway.
